(19) United States
(12) Patent Application Publication
(10) Pub. No.: US 2024/0058206 A1
(43) Pub. Date: Feb. 22, 2024

(54) SEXUAL STIMULATION APPARATUS AND CONTROL METHOD THEREOF, AND COMMUNICATION SYSTEM

(71) Applicant: HYTTO PTE. LTD., Singapore (SG)

(72) Inventors: Dan LIU, Guangzhou (CN); Jilin QIU, Guangzhou (CN)

(73) Assignee: HYTTO PTE. LTD., Singapore (SG)

(21) Appl. No.: 17/820,581

(22) Filed: Aug. 18, 2022

(51) Int. Cl. A61H 19/00

(52) U.S. Cl. CPC A61H 19/44; A61H 2201/1664; A61H 2201/0107; A61H 2201/5012

(57) ABSTRACT

Disclosed is a sexual stimulation apparatus including: a tube; a first coil disposed on the tube; a sliding component slidably disposed in the tube, the sliding component includes at least one end extending out of the tube; wherein the sliding component includes an end to which an adult toy is attachable, wherein the sliding component includes a magnetic structure configured to drive the sliding component to perform linear reciprocating motion according to a first driving force provided by the first coil, to cause the adult toy to perform linear reciprocating motion along with the sliding component, in a longitudinal direction of the tube. Also disclosed is a method for controlling the sexual stimulation apparatus and a communication system.

### TECHNICAL FIELD

The present disclosure relates to the field of adult toy, and in particular, to a sexual stimulation apparatus and control method thereof, and communication system.

### BACKGROUND

Masturbation is generally referred to as a natural and safe way to explore one's body i.e. stimulation of genital organs to obtain sexual pleasure. People use adult toys for exploring one's body (irrespective of gender) to attain sexual pleasure. Sexual stimulation apparatus is a kind of adult toy, which includes objects or devices that are primarily used to facilitate human sexual pleasure and typically to date have been designed to resemble human genitals for providing sexual pleasure to users, albeit perhaps in an abstracted form at times.

In the related art, the user is required to hold the sexual stimulation apparatus by hand while using the sexual stimulation apparatus, to keep the sexual stimulation apparatus in a suitable position for stimulation. Also, in some cases the user is required to drive the sexual stimulation apparatus by hand to achieve the stimulation effect. The user may feel cumbersome due to these operations and cannot perform other activities while using the sexual stimulation apparatus.

It should be noted that, information disclosed in the above background portion is provided only for better understanding of the background of the present disclosure, and thus it may contain information that does not form the prior art known by those ordinary skilled in the art.

### SUMMARY

The present disclosure provides a sexual stimulation apparatus and control method thereof, and communication system for inducing sexual stimulation to users.

According to one aspect, the present disclosure provides a sexual stimulation apparatus including: a tube; a first coil disposed on the tube; and a sliding component slidably disposed in the tube, the sliding component includes at least one end extending out of the tube, wherein the sliding component comprises an end to which an adult toy is attachable, wherein the sliding component includes a magnetic structure configured to drive the sliding component to perform linear reciprocating motion according to a first driving force provided by the first coil, to cause the adult toy to perform linear reciprocating motion along with the sliding component, in a longitudinal direction of the tube.

According to some embodiments, the sliding component includes a pushing rod having at least one end extending out of the tube, and wherein the magnetic structure is sleeved on the pushing rod.

According to some embodiments, the sliding component further includes a restoring structure sleeved on the pushing rod, wherein the restoring structure is propped against the tube and configured to restore a linear movement of the pushing rod.

According to some embodiments, the restoring structure includes a spring sleeved on and connected to the pushing rod, and wherein the spring is accommodated in the tube and propped against an end of the tube.

According to some embodiments, the restoring structure includes a first stopper, a second stopper and a spring disposed between the first stopper and the second stopper, and wherein the first stopper is propped against an end of the tube.

According to some embodiments, the sexual stimulation apparatus includes a second coil disposed at a side of the first coil in the longitudinal direction of the tube, wherein the second coil is configured to provide a second driving force to the sliding component, and the second driving force is opposite in direction to the first driving force.

According to some embodiments, the sexual stimulation apparatus includes a third coil disposed to be spaced apart from the first coil by a predetermined distance in the longitudinal direction of the tube, wherein the third coil is configured to apply a repulsive force to stop the sliding component.

According to some embodiments, the sexual stimulation apparatus includes an isolator configured to isolate the first coil from other coils.

According to some embodiments, the sexual stimulation apparatus includes a guide coaxially disposed at an end of the tube, wherein the guide is configured to guide the linear reciprocating motion of the sliding component in the longitudinal direction of the tube.

According to some embodiments, the sexual stimulation apparatus includes a housing having a cavity configured to accommodate the tube, wherein the tube is fixed to the housing by pair of fixers disposed at both ends of the tube, and wherein the housing includes a first via hole through which the sliding component is extended and a second via hole through which a heat dissipating device is disposed.

According to some embodiments, each of the fixer includes a first body and a second body opposite to the first body, and an assembly of the first body and the second body is cladded on an outer surface of the tube.

According to some embodiments, the housing includes a first body and a second body opposite to the first body, and wherein the cavity and the through are formed by an assembly of the first body and the second body.

According to some embodiments, the sexual stimulation apparatus includes an adapter connected to the sliding component, wherein the adult toy is connected to the adapter.

According to some embodiments, the adapter includes: a first body and a second body configured to hold the adult toy; a connector disposed on the first body or the second body, wherein the connector is detachably connected to the sliding component; a spring disposed between the first body and the second body; a quick release member configured to pass through the first body and the second body, wherein the spring is in a compressed state when the first body and second body are fixed together by the quick release member.

According to some embodiments, the sexual stimulation apparatus includes a supporter, wherein the housing is disposed on the supporter to stabilize the sexual stimulation apparatus and adjust an orientation of the adult toy.

According to another aspect, the present disclosure further provides a communication system includes: the sexual stimulation apparatus according to the above aspect, configured to receive a control signal; and at least one communication device communicated with the sexual stimulation apparatus to transmit the control signal, wherein the sexual stimulation apparatus is configured to operate according to the control signal.

According to some embodiments, the communication system includes a live broadcast room, wherein the at least one communication device includes a model device and a guest device configured to interact through the live broadcast room, and wherein the guest device is configured to send control request to the model device through the live broadcast room, and the model device is configured to transmit the control signal to the sexual stimulation apparatus.

According to some embodiments, the live broadcast room is configured to receive tip information from the guest device and forward the tip information to the model device, and wherein the model device is further configured to generate the control signal according to the tip information.

According to another aspect, the present disclosure further provides a method for controlling the sexual stimulation apparatus according to the above aspect, including:
activating a communication between the sexual stimulation apparatus and a communication device; receiving, by the sexual stimulation apparatus, control signal from the communication device; and controlling, by the sexual stimulation apparatus, the moving component to perform linear reciprocating motion, to cause the adult toy to perform linear reciprocating motion along with the sliding component, in a longitudinal direction of the tube.

According to some embodiments, the control signal includes frequency information and amplitude information, and the method further includes: controlling, by the sexual stimulation apparatus, the moving component to perform linear reciprocating motion according to the frequency information and amplitude information.

It is to be understood that both the foregoing general description and the following detailed description are exemplary and explanatory only and are not restrictive of the invention, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

The accompanying drawings are enclosed to provide a further understanding of the present disclosure and constitute a part of the specification, and together with the following detailed description, to serve for explanation of the present disclosure. But the accompanying drawings are not to be construed as limiting the present disclosure. In the drawings:

In order to more clearly illustrate the technical solutions of the embodiments of the present disclosure, drawings of the embodiments of the present disclosure will be briefly described below. It will be apparent that the drawings in the following description refer only to some embodiments of the present disclosure, and are not intended to limit the present disclosure.

FIG. 1 illustrates a schematic structure diagram of the sexual stimulation apparatus according an embodiment of the present disclosure;

FIG. 2 illustrates an exploded view of the sexual stimulation apparatus according an embodiment of the present disclosure;

FIG. 3 illustrates a schematic structure diagram of the adapter of the sexual stimulation apparatus according an embodiment of the present disclosure;

FIG. 4 illustrates a schematic structure diagram of the supporter of the sexual stimulation apparatus according an embodiment of the present disclosure;

FIG. 5 illustrates a side view of an embodiment of the sexual stimulation apparatus according an embodiment of the present disclosure;

FIG. 6 illustrates another side view of an embodiment of the sexual stimulation apparatus according an embodiment of the present disclosure;

FIG. 7 illustrates a schematic block diagram of the communication system according to an example of the present disclosure; and

FIG. 8 illustrates a scenario of a method for controlling the sexual stimulation apparatus according to an example of the present disclosure.

### DETAILED DESCRIPTION

Hereinafter, the sexual stimulation apparatus according to the present disclosure will be described in further detail with reference to the accompanying drawings and particular embodiments of the present disclosure, such that those skilled in the art may have a better understanding of technical solutions of the present disclosure.

In order to make the objectives, technical solutions and advantages of the embodiments of the present disclosure more clear, the technical solutions of the embodiments of the present disclosure will be described clearly and completely in conjunction with the accompanying drawings of the embodiments of the present disclosure. It is obvious that the described embodiments are part of the embodiments rather than all embodiments of the present disclosure. All other embodiments obtained by one of ordinary skill in the art based on the described embodiments of the present disclosure without the need for creative work are within the scope of the present disclosure.

In the description of the embodiments of the present disclosure, it is to be noted that the directional or positional relationships indicated by the terms “upper”, “lower”, “top”, “bottom” or the like are based on the directional or positional relationships shown in the drawings, which are provided only for the purpose of facilitating the description and simplification of the description and is not intended or implied that the device or element referred to must have a specific orientation, constructed or operated in a particular orientation. Accordingly, it should not be construed as a limitation of this disclosure.

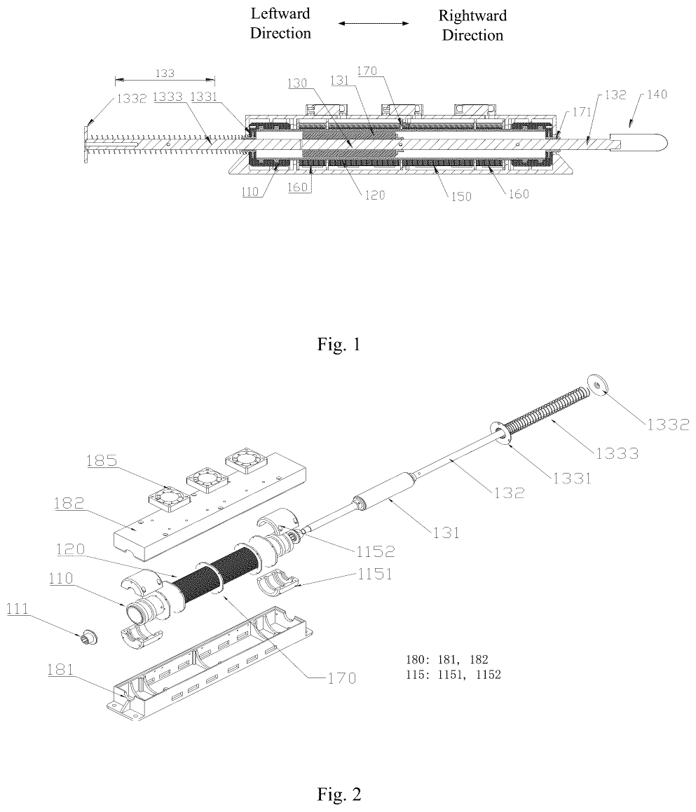

FIG. 1 illustrates a schematic structure diagram of the sexual stimulation apparatus according an embodiment of the present disclosure, and FIG. 2 illustrates an exploded view of the sexual stimulation apparatus according an embodiment of the present disclosure. According to the present embodiment, the sexual stimulation apparatus may include a sliding component configured to perform linear reciprocating motion along a longitudinal direction, a pushing rod is connected to the sliding component and having a free end connected thereto an adult toy. With such a configuration, when the sliding component is performing linear reciprocating motion along the longitudinal direction, the adult toy will move along with the sliding component to induce sexual stimulation to the users. As shown in FIGS. 1 and 2, the sexual stimulation apparatus according to an embodiment of the present disclosure includes: a tube 110; a first coil 120 disposed on the tube 110; a sliding component 130 slidably disposed in the tube 110, the sliding component 130 includes at least one end extending out of the tube 110, wherein the sliding component 130 includes an end to which an adult toy 140 is attachable, wherein the sliding component includes a magnetic structure 131 configured to drive the sliding component 130 to perform linear reciprocating motion according to a first driving force provided by the first coil 120, to cause the adult toy 140 to perform linear reciprocating motion along with the sliding component 130, in a longitudinal direction of the tube 110.

In this embodiment, when electric current is applied to the first coil 120, it may generate and apply electromagnetic force, i.e., the first driving force, onto the magnetic structure 131 of the sliding component 130, thereby driving the sliding component 130 to perform linear motion in the longitudinal direction of the tube 110. In some embodiments, the first driving force may be applied in different directions, such that the linear motion of the sliding component 130 may be changed in opposite directions, thereby driving the sliding component 130 to perform linear reciprocating motion. In this way, the adult toy 140 connected to the sliding component 130 will perform linear reciprocating motion along with the sliding component 130, thereby applying stimulation to the user.

According to some embodiments, the sliding component 130 includes a pushing rod 132 having at least one end extending out of the tube 110, and wherein the magnetic structure 131 is sleeved on the pushing rod 132.

In this way, the magnetic structure 131 is sleeved on and fixed to the pushing rod 132, and the assembly of the magnetic structure 131 and the pushing rod 132 is sleeved in the first coil 120 while moveable relative to the first coil 120. Accordingly, the first force can be applied to the pushing rod 132 along the longitudinal direction of the tube 110 and cause the linear reciprocating motion of the sliding component 130. Also, by changing the direction and/or magnitude of the current flowing through the first coil 120, the first force may have different direction and/or magnitude, thereby controlling the moving direction and moving status of the sliding component 130. In the embodiment, the sexual stimulation apparatus may further include a controller connected to a power supply. The power supply may be a built-in power supply, or may be an external supply. The built-in power supply may include for example a battery mounted in the sexual stimulation apparatus, and the external power supply may include an adaptor connected to an external DC or AC power source. The power supply may be configured to provide electrical power to generate the current flowing through the coils through the controller. In particular, the controller may be configured to receive electric power from the power supply, and control the direction and/or magnitude of the current flowing through the coils.

According to some embodiments, the sliding component 130 further includes a restoring structure 133 sleeved on the pushing rod 132, wherein the restoring structure 133 is propped against the tube and configured to restore a linear movement of the pushing rod 132. In some embodiment, the restoring structure 133 may include a spring sleeved on and connected to the pushing rod 132, and wherein the spring is accommodated in the tube 110 and propped against an end of the tube 110. FIG. 1 illustrates an example in which the restoring structure 133 (e.g., the spring) is sleeved on the pushing rod 132 and disposed outside the tube 110, and has an end propped against an outer end of the tube 110. However, the position of the restoring structure 133 is not limited thereto. In other implementations, the restoring structure 133 (e.g., the spring) may be sleeved on the pushing rod and disposed inside the tube, and may have an end propped against an inner end of the tube.

In this way, as the spring is connected to the pushing rod 132 and is propped against an end of the tube 110, when the pushing rod 132 is moving in the first direction (e.g., rightward direction of FIG. 1), the spring will be compressed or stretched and generate a spring force, the spring force is applied to the pushing rod 132, and when the pushing rod 132 is moving back in the second direction (e.g., leftward direction of FIG. 1) opposite to the first direction, the spring force will help the pushing rod 132 to restore its position quickly.

According to some embodiments, the restoring structure 133 may include a first stopper 1331, a second stopper 1332 and a spring 1333 disposed between the first stopper 1331 and the second stopper 1332, and wherein the first stopper 1331 is propped against an end of the tube 110. As discussed above, the first stopper 1331 may be propped against an outer end of the tube 110 as shown in FIGS. 1 and 2, while in other embodiment, when the spring 1333 is disposed inside the tube 110, the first stopper 1331 may be propped against an inner end of the tube 110.

In this way, both ends of the spring 1333 is limited by the first stopper 1331 and the second stopper 1332, and therefore the spring 1333 may be compressed when the first stopper 1331 and the second stopper 1332 are moving towards each other, or may be stretched when the first stopper 1331 and the second stopper 1332 are moving away from each other. In the embodiment shown in FIG. 1, the second stopper 1332 is fixed at an end of the pushing rod 132 and the first stopper 1331 is fixed to the tube 110, when the pushing rod 132 moves forward to the right direction of FIG. 2, the spring 1333 is compressed and will generate and apply a spring force to the pushing rod 132 in the left direction of FIG. 2. Accordingly, the spring force may restore the linear movement of the pushing rod 132.

According to some embodiments, the sexual stimulation apparatus includes a second coil 150 disposed at a side of the first coil 120 in the longitudinal direction of the tube 110, wherein the second coil 150 is configured to provide a second driving force to the sliding component 130, and the second driving force is opposite in direction to the first driving force.

In this embodiment, a second coil 150 is further provided to provide the second driving force opposite in direction to the first driving force. As shown in FIG. 1, in this embodiment, when the magnetic structure 131 is driven by the first driving force of the first coil 120 and moving in the rightward direction of FIG. 1, the magnetic structure 131 may at least partly move out of the first coil 120 and goes into the second coil 150. Therefore, the second force generated by the second coil 150 may be applied to the magnetic structure 131 to drive the magnetic structure 131 to move in the leftward direction of FIG. 1. The first coil 120 and the second coil 150 may be disposed close to each other such that when the magnetic structure 131 leaves the first coil 120, it can directly enter the second coil 150. In other embodiment, the positions of the first coil 120 and the second coil 150 can be determined according to the actual design, and at the position where the first and second driving forces are required to be applied.

According to some embodiments, the sexual stimulation apparatus includes a third coil 160 disposed to be spaced apart from the first coil 120 by a predetermined distance in the longitudinal direction of the tube 110, wherein the third coil 160 is configured to apply a repulsive force to stop the sliding component 130. In some implementations, the third coil 160 may also be configured to apply force to the sliding component 130 to cause the sliding component 130 to accelerate forward or accelerate backward.

In this embodiment, the third coil 160 is disposed at a terminal of a stroke of the sliding component 130. That is, the third coil 160 is disposed a position where the farthest the magnet travels. The third coil 160 may generate a repulsive force large enough to stop the sliding component 130 in a very short time. In some implementations, the third coil 160 may also be configured to apply force to the sliding component 130 to cause the sliding component 130 to accelerate forward or accelerate backward.

In this way, the stroke of the sliding component 130 may be defined by the third coil 160. According to some embodiments, at least one third coil 160 is provided at the forward direction of the sliding component 130, while in some other embodiments, two third coils 160 may be provided at both the forward direction and the backward direction of the sliding component 130, to define both terminals of the stroke. By using the third coil 160, vibration of the sexual stimulation apparatus may be reduced in compassion to physical stoppers which may otherwise have direct physical impact to the sliding component 130 and generate heavy vibration.

According to some embodiments, the sexual stimulation apparatus includes an isolator 170 configured to isolate the first coil 120 from other coils (e.g., the second coil 150). The isolator 170 may be disposed in any adjacent coils to isolate them from one another. According, electromagnetic interference between the coils may be prevented.

According to some embodiments, the sexual stimulation apparatus includes a guide 111 coaxially disposed at an end of the tube 110, wherein the guide 111 is configured to guide the linear reciprocating motion of the sliding component 130 in the longitudinal direction of the tube 110. As shown in FIG. 2, the guide 111 may have a ring-shaped structure and is disposed at the end of the tube 110. The pushing rod 132 may pass through the guide 111, therefore movement of the pushing rod 132 other than the longitudinal direction of the tube 110 may be restricted by the guide 111. In the embodiment shown in FIG. 2, only one guide 111 is illustrated at an end of the tube 110, while in other embodiments, another guide 111 can be also disposed at the other end of the tube 110 to guide the movement of the pushing rod 132.

According to some embodiments, the sexual stimulation apparatus includes a housing 180 having a cavity configured to accommodate the tube 110, wherein the tube 110 is fixed to the housing 180 by pair of fixers 115 disposed at both ends of the tube 110, and wherein the housing 180 includes a first via hole through which the sliding component 130 is extended and a second via hole through which a heat dissipating device 185 is disposed.

The first via hole is positioned coaxially with the pushing rod 132 in the longitudinal direction of the tube 110, such that the sliding component 130, i.e., the pushing rod 132, is extended out of the housing 180 through the first via hole. In some embodiment, another first via hole can be also provided at the other side of the housing 180, such that the other end of the sliding component 130, i.e., the pushing rod 132, can be extended out of the housing 180 at the other side. The second via hole can be disposed on the body of the housing 180, and the second via hole may be disposed at the position corresponding to the coils where most heat will be generated. The second via hole may be single or multiple with one or more heat dissipating device 185 disposed thereon. In some embodiment, the heat dissipating device 185 may include a fan generating a flow of air through the second via hole for heat dissipating.

According to some embodiments, each of the fixer 115 includes a first body 1151 and a second body 1152 opposite to the first body 1151, and an assembly of the first body 1151 and the second body 1152 is cladded on an outer surface of the tube. The fixer 115 may hold the tube 110 in the housing 180 and fix the tube 110 to the housing 180.

According to some embodiments, the housing 180 includes a first body 181 and a second body 182 opposite to the first body 181, and wherein the cavity and the through hole are formed by an assembly of the first body 181 and the second body 182. By this structure, the assembling process and/or maintaining of the sexual stimulation apparatus will be easily performed as the first body 181 and the second body 182 are separate structures and the cavity of the housing 180 can be easily exposed and accessible.

In some embodiments, the adult toy 140 may include a connection means connected to the pushing rod 132. For example, a quick release connector may be provided in the adult toy 140. Accordingly, the adult toy 140 may be connected easily to the pushing rod 132 and may be detached for cleaning or replacement easily. Other connection means will be possible according to the concept of the present disclosure, for example, a screw structure, a snap structure, an interlock structure or the like are also possible for the connection between the adult toy 140 and the pushing rod 132.

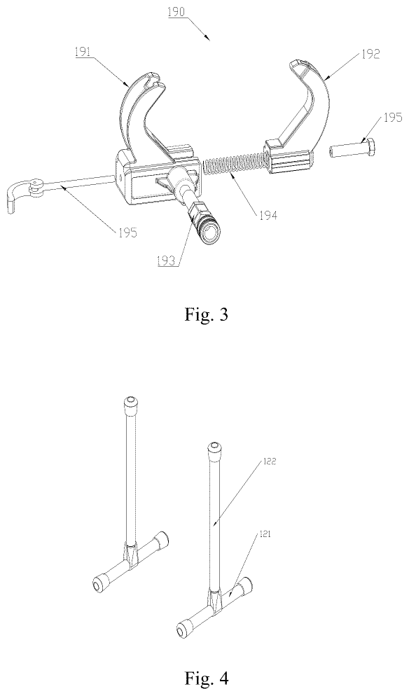

According to some embodiments, the sexual stimulation apparatus includes an adapter 190 connected to the sliding component 130, wherein the adult toy 140 is connected to the adapter 190. FIG. 3 illustrates a schematic structure diagram of an adapter of the sexual stimulation apparatus according an embodiment of the present disclosure.

As shown in FIG. 3, according to some embodiments, the adapter 190 includes: a first body 191 and a second body 192 configured to hold the adult toy 140; a connector 193 disposed on the first body 191 or the second body 192, wherein the connector 193 is detachably connected to the pushing rod 132; a spring 194 disposed between the first body 191 and the second body 192; a quick release member 195 configured to pass through the first body 191 and the second body 192, wherein the spring 194 is in a compressed state when the first body 191 and second body 192 are fixed together by the quick release member 195.

In this embodiment, when the adapter 190 is attached to the pushing rod 132, the adult toy 140, with or without the connection means to the pushing rod 132, can be fixed to the pushing rod 132 by the adapter 190. For example, a part of the adult toy 140 can be placed between the first body 191 and the second body 192, and when the first body 191 and the second body 192 are fixed together by the quick release member 195, the adult toy 140 is fixed to the pushing rod 132 by the adapter 190. In this case, when the first body 191 and the second body 192 are used to fix the adult toy 140, it will be unnecessary to provide a connection means in the adult toy, and thus the adult toy with any shape or form can be attached to the pushing rod 132. Also, when the quick release member 195 is released, the first body 191 and the second body 192 may separate easily with the elastic force of the spring 194. Moreover, the adapter 190 may also hold an extension rod connected to the adult toy 140, to extend the application range of the sexual stimulation apparatus. Also, in an embodiment, the adapter 190 may be used as an extension rod to extend the length of the pushing rod 132, i.e., the application range of the sexual stimulation apparatus. It should be noted that FIG. 3 illustrates a particular shape of the adapter 190, while the embodiments of the present disclosure are not limited to this particular shape and structure. For example, the first body 191 and the second body 192 may have other shape such that when they are fixed together, more than one adult toy can be held by the adaptor 190. Also, the adaptor is not limited to the clip shape shown in FIG. 3, and apparently the first body 191 and the second body 192 may have other shape, e.g., a ring shape, that can hold the adult toy.

According to some embodiments, as shown in FIGS. 4-6, the sexual stimulation apparatus further includes a cover skin 200 configured to accommodate the housing 180. The cover skin 200 may include a through hole and the pushing rod 132 is protruded from the through hole. The cover skin 200 is disposed on a supporter 210 to stabilize the sexual stimulation apparatus and adjust an orientation of the adult toy 140.

The cover skin 200 is provided such that the sexual stimulation apparatus may have an attractive appearance. Nevertheless, it should be noted that the cover skin 200 is not essential, and the housing 180 may be designed to have a proper appearance. In this case, the housing 180 is directed disposed on the supporter 210 to stabilize the sexual stimulation apparatus and adjust the orientation of the adult toy 140.

In this embodiment, as shown in FIG. 4, the supporter 210 may include at least two feet 121 and at least two legs 122, wherein the foot 121 may be disposed on a surface such as a table, a floor, a bed or the like, and by providing at least two feet 121, the sexual stimulation apparatus can be placed stably on the surface. Also, the leg 122 is fixed to the foot 121 and may extend upward from the foot 121. The housing 200 may be attached to the at least two legs at a certain height such that the pushing rod 132 and the adult toy 140 can be held at a desired position from the surface.

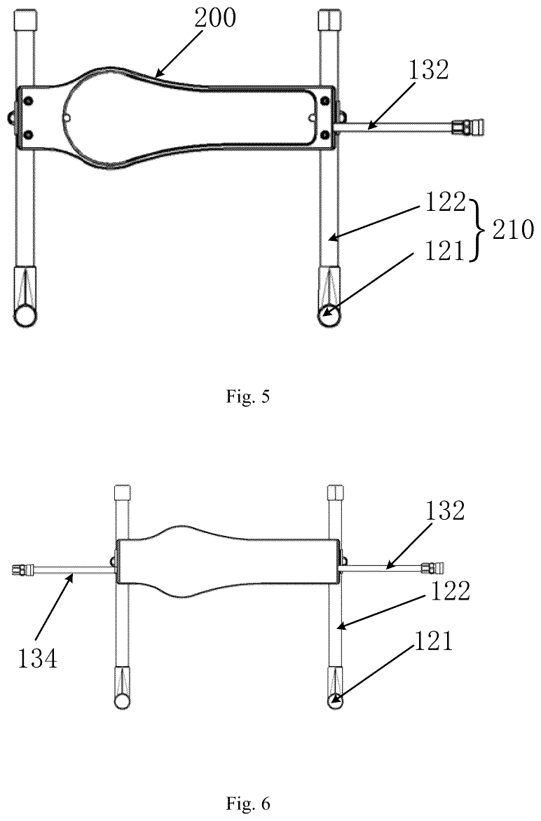

FIG. 5 illustrates a sexual stimulation apparatus having one pushing rod 132 and FIG. 6 illustrates a sexual stimulation apparatus having both the pushing rod 132 and an opposite pushing rod 134. The opposite pushing rod 134 may be formed by extending the pushing rod 132 in the opposite direction, or may be formed by attaching a rod to the opposite end of the pushing rod 132. The opposite pushing rod 134 may be extended out from the housing 180 and the cover skin 200 such that the end of the opposite pushing rod 134 is free. The adult toy 140 and/or the adapter 190 can be fixed to the free end of the opposite pushing rod 134. Details for the connection may refer to the above embodiment regarding the pushing rod 132, which will not be repeated herein.

By providing the opposite pushing rod 134, another adult toy 140 can be fixed to the opposite pushing rod 134, and therefore two users may use the sexual stimulation apparatus at the same time, thereby improving the fun and interactivity of the sexual stimulation apparatus. As an example, the pushing rod 132 and the opposite pushing rod 134 may both be connected to the same type of adult toy, such as each being connected to a dildo, or each being connected to a masturbation toy. Also, in another example, the pushing rod 132 and the opposite pushing rod 134 may respectively connected to a different type of adult toy, such as one being connected to a dildo while the other one being connected to a masturbation toy.

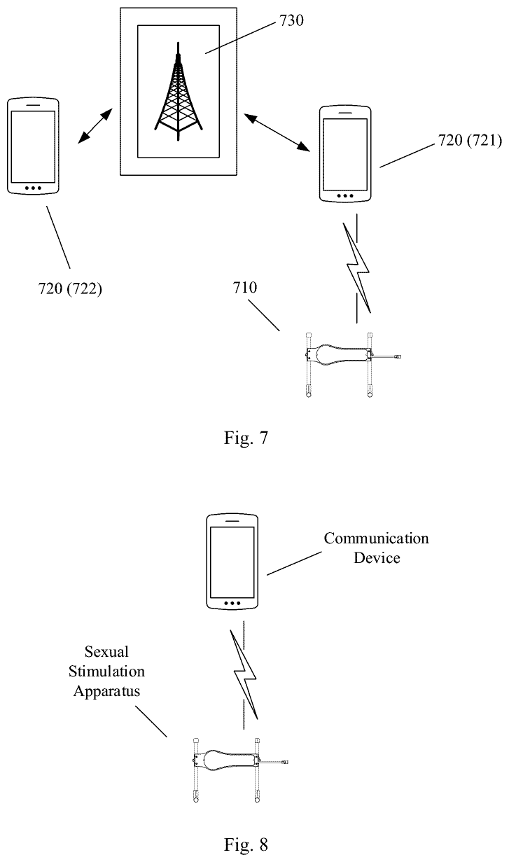

FIG. 7 illustrates a schematic block diagram of the communication system according to an example of the present disclosure. As shown in FIG. 7, the communication system including: the sexual stimulation apparatus 710 according to the above embodiments, configured to receive a control signal; and at least one communication device 720 communicated with the sexual stimulation apparatus 710 to transmit the control signal, wherein the sexual stimulation apparatus 710 is configured to operate according to the control signal.

In some embodiments, the communication system may include a live broadcast room 730, wherein the at least one communication device 720 includes a model device 721 and a guest device 722 configured to interact through the live broadcast room 730, and wherein the guest device 722 is configured to send control request to the model device 721 through the live broadcast room 730, and the model device 721 is configured to transmit the control signal to the sexual stimulation apparatus 710.

According to the present embodiment, the user of the guest device 722, i.e., the guest, may access to the live broadcast room 730 when the model using the model device 720 is performing in the live broadcast room 730. The guest may interact with the model through the live broadcast room 730, by for example chatting, or other broadcast room functions such as subscribing, following, like (thumbs-up), donating or the like. The interacting information may be transmitted to the model device 721, and the model device 720 may transmit corresponding control signal the sexual stimulation apparatus 710, to control the operation of the sexual stimulation apparatus 710.

In some embodiments, the interacting may involve donating. That is, the guest may make a donation (i.e., give a tip) to the model through the live broadcast room 730, and the live broadcast room 730 may receive the tip information from the guest device 722 and forward the tip information to the model device 721. The model device 721 may generate the control signal according to the tip information. For example, according to different tip information, different control signal may be generated to control the operating status, such as the shock frequency, intensity, amplitude, duration and the like of the sexual stimulation apparatus. Also, the control pattern for the operating status according to the tip information can be predetermined by the model.

In this case, by using the communication system, the sexual stimulation apparatus can be operated with more fun and interactivity when the model and the guest are interacting through the live broadcast room 730.

FIG. 8 illustrates a scenario of a method for controlling the sexual stimulation apparatus according to an example of the present disclosure. As shown in FIG. 8, the scenario of a method for controlling the sexual stimulation apparatus includes a communication device and the sexual stimulation apparatus. The method for controller the sexual stimulation apparatus may include: activating a communication between the sexual stimulation apparatus and a communication device; receiving, by the sexual stimulation apparatus, control signal from the communication device; and controlling, by the sexual stimulation apparatus, the moving component to perform linear reciprocating motion to drive the adult toy to perform linear reciprocating motion. In some embodiments, the control signal includes frequency information and amplitude information, and the method may further include: controlling, by the sexual stimulation apparatus, the moving component to perform linear reciprocating motion according to the frequency information and amplitude information.

According to the present embodiment, the operating of the sexual stimulation apparatus can be controlled according to the control signal from the communication device, therefore while using the sexual stimulation apparatus, the user will not be required to operate the sexual stimulation apparatus manually, and thus the sexual stimulation apparatus can be operated in a more effective way. Further, the communication device may be implemented by for example the model device according to the above embodiments, and therefore the model may use the sexual stimulation apparatus according to the interacting with the guest through the live broadcast room, thereby improving the fun and interactivity of the sexual stimulation apparatus.

It should be appreciated that, the above embodiments are exemplary implementations for illustrating the principle of the present disclosure only, while the present disclosure is not limited thereto. Various modifications and improvements are possible to those of ordinary skill in the art without departing from the spirit and essence of the present disclosure. All these modifications and improvements will also fall into the protection scope of the present disclosure.

What is claimed is:

1. A sexual stimulation apparatus comprising:
a tube;
a first coil disposed on the tube; and
a sliding component slidably disposed in the tube, the sliding component comprises at least one end extending out of the tube,
wherein the sliding component comprises an end to which an adult toy is attachable, wherein the sliding component comprises a magnetic structure configured to drive the sliding component to perform linear reciprocating motion according to a first driving force provided by the first coil, to cause the adult toy to perform linear reciprocating motion along with the sliding component, in a longitudinal direction of the tube.

2. The sexual stimulation apparatus according to claim 1, wherein the sliding component comprises a pushing rod having at least one end extending out of the tube, and wherein the magnetic structure is sleeved on the pushing rod.

3. The sexual stimulation apparatus according to claim 2, wherein the sliding component further comprises a restoring structure sleeved on the pushing rod, wherein the restoring structure is propped against the tube and configured to restore a linear movement of the pushing rod.

4. The sexual stimulation apparatus according to claim 3, wherein the restoring structure comprises a spring sleeved on and connected to the pushing rod, and wherein the spring is accommodated in the tube and propped against an end of the tube.

5. The sexual stimulation apparatus according to claim 3, wherein the restoring structure comprises a first stopper, a second stopper and a spring disposed between the first stopper and the second stopper, and wherein the first stopper is propped against an end of the tube.

6. The sexual stimulation apparatus according to claim 1, further comprising a second coil disposed at a side of the first coil in the longitudinal direction of the tube, wherein the second coil is configured to provide a second driving force to the sliding component, and the second driving force is opposite in direction to the first driving force.

7. The sexual stimulation apparatus according to claim 1, further comprising a third coil disposed to be spaced apart from the first coil by a predetermined distance in the longitudinal direction of the tube, wherein the third coil is configured to apply a repulsive force to stop the sliding component.

8. The sexual stimulation apparatus according to claim 1, further comprising an isolator configured to isolate the first coil from other coils.

9. The sexual stimulation apparatus according to claim 1, further comprises a guide coaxially disposed at an end of the tube, wherein the guide is configured to guide the linear reciprocating motion of the sliding component in the longitudinal direction of the tube.

10. The sexual stimulation apparatus according to claim 1, further comprising a housing having a cavity configured to accommodate the tube, wherein the tube is fixed to the housing by pair of fixers disposed at both ends of the tube, and wherein the housing comprises a first via hole through which the sliding component is extended and a second via hole through which a heat dissipating device is disposed.

11. The sexual stimulation apparatus according to claim 10, wherein each of the fixer comprises a first body and a second body opposite to the first body, and an assembly of the first body and the second body is cladded on an outer surface of the tube.

12. The sexual stimulation apparatus according to claim 10, wherein the housing comprises a first body and a second body opposite to the first body, and wherein the cavity and the through are formed by an assembly of the first body and the second body.

13. The sexual stimulation apparatus according to claim 1, wherein further comprising an adapter connected to the sliding component, wherein the adult toy is connected to the adapter.

14. The sexual stimulation apparatus according to claim 13, wherein the adapter comprises:
a first body and a second body configured to hold the adult toy;
a connector disposed on the first body or the second body, wherein the connector is detachably connected to the sliding component;
a spring disposed between the first body and the second body;
a quick release member configured to pass through the first body and the second body, wherein the spring is in a compressed state when the first body and second body are fixed together by the quick release member.

15. The sexual stimulation apparatus according to claim 10, further comprising a supporter, wherein the housing is disposed on the supporter to stabilize the sexual stimulation apparatus and adjust an orientation of the adult toy.

16. A communication system comprising:
the sexual stimulation apparatus according to claim 1, configured to receive a control signal; and
at least one communication device communicated with the sexual stimulation apparatus to transmit the control signal,
wherein the sexual stimulation apparatus is configured to operate according to the control signal.

17. The communication system according to claim 16, further comprising a live broadcast room, wherein the at least one communication device comprises a model device and a guest device configured to interact through the live broadcast room, and wherein the guest device is configured to send control request to the model device through the live broadcast room, and the model device is configured to transmit the control signal to the sexual stimulation apparatus.

18. The communication system according to claim 17, wherein the live broadcast room is configured to receive tip information from the guest device and forward the tip information to the model device, and
wherein the model device is further configured to generate the control signal according to the tip information.

19. A method for controlling the sexual stimulation apparatus according to claim 1, comprising:
activating a communication between the sexual stimulation apparatus and a communication device;
receiving, by the sexual stimulation apparatus, control signal from the communication device; and
controlling, by the sexual stimulation apparatus, the moving component to perform linear reciprocating motion, to cause the adult toy to perform linear reciprocating motion along with the sliding component, in a longitudinal direction of the tube.

20. The method according to claim 19, wherein the control signal comprises frequency information and amplitude information, and the method further comprises:
controlling, by the sexual stimulation apparatus, the moving component to perform linear reciprocating motion according to the frequency information and amplitude information.
